(19) United States
(12) Patent Application Publication
(10) Pub. No.: US 2004/0080174 A1
(43) Pub. Date: Apr. 29, 2004

(54) Truck bed extension systems and methods for their modification

(76) Inventor: Terrence J. Buelna, Montecito, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/282,934

(22) Filed: Oct. 28, 2002

(51) Int. Cl. B62C 1/06

(52) U.S. Cl. 296/26.11

(57) ABSTRACT

Methods, systems and apparatus are provided to modify the operation and function of known truck bed extender systems. The function and operation are modified to provide for a lockable vertical position for a U-shaped frame which otherwise has only forward and rearward horizontal positions. In one embodiment, a bracket is provided which has an anchor hole for receiving a locking pin on the frame. In the second embodiment, a bracket is provided which permits horizontal translation of both the frame pivot pin and an associated anchor hole to permit both raising of the frame and forwardly positioning the frame within the truck bed.

### BACKGROUND OF THE INVENTION

1. Field of the Invention. The present invention relates generally to automotive equipment. More particularly, the present invention relates to methods and systems for modifying the function of truck bed extension systems.

Pick-up trucks are no longer used solely in the construction and maintenance professions. In recent years, pick-up trucks have become everyday transportation for families and individuals who appreciate the ability to haul loads in the storage bed located behind the truck cab.

As the number and types of uses of the pick-up truck have grown, the limitations of a truck bed having a fixed size and geometry have become more apparent. To overcome such limitations, a variety of “truck bed extenders” have been developed. Generally, such extenders are mounted at the end of the truck bed and can be configured to extend the length of the truck bed, typically by creating an extended wall which lies over the folded down tailgate. A number of U.S. patents describing such truck bed extenders are listed hereinafter.

Of particular interest to the present invention, truck bed extension systems comprising a U-shaped frame having a pair of side walls joined by a back wall are described in U.S. Pat. Nos. 5,700,047 and 6,113,173, the full disclosures of which are incorporated herein by reference. The U-shaped frame is adapted to be pivotally attached to the walls of the truck bed so that the frame may be pivoted between a rearwardly extended horizontal position (which increases the available area of the truck bed) and a forwardly shortened horizontal position (which divides the available area of the truck bed into two sections, each having a smaller area). Truck bed extension systems displaying the designs described in the '047 and '173 patents are commercially available from AMP Research, Irvine, Calif., under the Bed X-Tender tradename. Information concerning the commercial designs is available at AMP Research's website located at www.amp-research.com/bedx.htm. Paper copies of the website information generally available at the time of filing the present application are being submitted together with the present application.

While the truck bed extension systems of AMP Research have enjoyed significant commercial success, they do suffer from certain shortcomings. In particular, the U-shaped frames of the truck bed extenders can be maintained only in their forwardly or rearwardly extended positions. There is no provision made for locking the frames in a vertical position so that access to the truck bed beneath the raised frame can be provided and maintained. While it is possible to manually hold the frames in a vertical position, it can be very inconvenient for one person to load materials while trying to hold the frame up.

A second shortcoming arises from the inability to close the tailgate with the U-shaped frame held vertically. It will be appreciated that in some instances it would be desirable to be able to close the tailgate while having the frame raised so that it is not dividing the available truck bed space into two parts. With the present Bed X-Tender product designs, it is simply not possible to close the tailgate with the frame raised.

For these reasons, it would be desirable to provide improved truck bed extension systems, as well as methods and apparatus for modifying the existing commercial systems to overcome the shortcomings noted above. In particular, it would be desirable to provide truck bed extension systems, as well as methods and apparatus for modifying pre-existing systems, to permit raising and maintenance of the U-shaped extension frame in a vertical orientation so that access can be had beneath the raised frame. It would be further desirable to provide improved systems as well as methods and apparatus for the modification of existing systems to permit closure of the tailgate while the truck bed extender is in a raised configuration. At least some of these objectives will be met by the inventions described below.

2. Description of the Background Art. U.S. Pat. Nos. 5,700,047 and 6,113,173 have been described above. Other patents describing truck bed extenders and related technology include U.S. Pat. Nos. 6,340,190; 6,283,525; 6,120,076; and 6,019,410. Information from the AMP Research website (www.amp-research.com/bedx.htm) is also of interest.

### BRIEF SUMMARY OF THE INVENTION

The present invention includes methods, apparatus, and systems which provide improvements to and over known truck bed extension systems of the type having a U-shaped frame which can be rotated or swung between a rearwardly extended position where it lies over a truck's tailgate to increase the available cargo receiving area of the truck bed and a forwardly shortened position which divides the normally available truck bed area into two sections. The U-shaped frames include a pair of side walls joined by a back wall, where the side walls are adapted to pivotally attach to a vertical surface in the truck bed, typically either or both of the vertical posts which define the tailgate opening at the rear of the truck bed.

In a first aspect of the present invention, a method for modifying a truck bed extender structure comprises establishing at least a third position where the U-shaped frame is held vertically relative to the truck bed floor. That is, in addition to the rearwardly extended and forwardly shortened positions described above, methods according to the present invention provide for at least a third position wherein the U-shaped frame is generally vertical and locked so that it remains in said third position until released. Usually, establishing the at least third position comprises mounting a bracket on the vertical surface of the truck bed, where the bracket provides an anchor point which receives a releasable latch on the U-shaped frame. Typically, the anchor point is an opening formed in the bracket, and the release on the latch is a locking pin which reciprocatably mates with the opening when the U-shaped frame is in its vertical third position. Conveniently, the locking pin may be provided as part of the truck bed extender structure which is being modified according to the methods of the present invention. Thus, it may be necessary to provide only the bracket, together with attachment hardware, to permit modifying commercially available truck bed extension systems. Alternatively, the bracket or other apparatus needed for providing the third vertical position may be provided as part of the factory installed truck bed extension system and/or as part of an “after market” installed system.

In a first embodiment, the bracket which is provided comprises a simple plate having an opening for receiving the releasable latch on the U-shaped frame. The plate is secured onto the vertical surface, typically using the pre-existing pivot pin which receives and supports the side wall of the U-shaped frame. Attachment using the pivot pin is preferable since it requires minimal or no drilling or direct modification of the truck bed to permit bracket mounting. Alternatively, of course, it would be possible to bolt, weld, glue, or otherwise mount bracket(s), plate(s), frames, or other structure for receiving the releasable latch of the U-shaped frame when the frame is in the desired vertical position.

The present invention further comprises improved truck bed extender systems. The improved systems are of the type which include a U-shaped frame having a pair of side walls joined by a back wall, where the side walls are adapted to pivotally attach to opposed vertical surfaces disposed across the rear of a truck bed. The U-shaped frame may thus be pivoted between a rearwardly extended horizontal position and a forwardly shortened horizontal position, generally as described above. The improvement in the truck bed extender system comprises a first bracket mountable on a first vertical surface of the truck bed, where the first bracket provides an anchor point which receives a releasable latch on the U-shaped frame to lock the frame in the third generally vertical position. Optionally, the improvement may further comprise a second bracket mountable on a second vertical surface of the truck bed. The second bracket will receive a second releasable latch on the U-shaped frame to also lock the frame in the third generally vertical position.

In the first specific embodiments, the bracket comprises a plate having an opening which defines the anchor point when the bracket is properly mounted on the vertical surface of the truck bed. The opening is mounted on the bracket so that, when the bracket is properly mounted on the vertical surface, the opening receives a reciprocatable locking pin disposed on the side wall of the U-shaped frame. Other anchor structures, such as pins, detents, clasps, screws, bolts, and the like, could also be provided for selectively latching the U-shaped frame in vertical orientation.

Optionally, the bracket may comprise a base and a slide, with the base being mountable on the vertical surface of the truck bed. The slide includes the opening for receiving the reciprocatable locking pin or other latching mechanism. Thus, the U-shaped frame may be moved horizontally, relative to the truck bed, by sliding the slide in the base. The slide also includes the anchor point for mounting and pivoting the U-shaped frame. Since the U-shaped frame pivots about the axis defined by the anchor point (actually two anchor points on opposed sides of the truck bed), shifting of the slide will cause both the pivot axis of the frame and the locking point of the frame to move relative to the truck bed. In this way, the frame may be moved forwardly, rotated upwardly about the pivot axis, and locked in the vertical orientation by engaging the locking pin into the opening on the slide. The frame can thus be moved horizontally forwardly when it is desired to raise the frame and close the tailgate.

In a still further aspect of the present invention, a bracket is provided for use in combination with a truck bed extender structure. The truck bed extender structure comprises a U-shaped frame having a pair of side walls joined by a back wall. The side walls are adapted to pivotally attach to a vertical surface in a truck bed so that the frame may be pivoted between a rearwardly extended horizontal position and a forwardly shortened horizontal position. The bracket comprises a base mountable on the vertical surface of the truck bed. The bracket comprises an anchor point, which receives a releasable latch on the U-shaped frame to lock said U-shaped frame in the third generally vertical position. The bracket includes at least a base which is directly secured to the vertical surface of the truck bed, where the base comprises or provides an opening which defines the anchor point and which receives a reciprocatable locking pin on the side wall of the U-shaped frame. Alternatively, the bracket may comprise the base together with a slide which is slidably received in the base. The slide comprises both the opening which receives the reciprocatable locking pin and also provides the pivot point about which the U-shaped frame pivots. Thus, the horizontal position of the frame may be moved relative to the truck bed, and the frame may be raised vertically and locked in place at any point along the horizontal length of travel.

### BRIEF DESCRIPTION OF THE DRAWINGS

FIGS. 1-3 illustrate a prior art truck bed extension system of the type which may be modified by the present invention.

FIG. 4 illustrates a first embodiment of a bracket which may be used in accordance with the principles of the present invention for modifying the prior art truck bed extension system of FIGS. 1-3.

FIG. 5 illustrates the principles of operation of the bracket of FIG. 4.

FIG. 6 illustrates a second embodiment of a bracket which may be used in accordance with the principles of the present invention to modify the truck bed extension system of FIGS. 1-3.

FIG. 7 is a detailed, exploded view of the bracket of FIG. 6.

FIGS. 8-9 illustrate the principles of operation of the bracket of FIGS. 6-7.

### DETAILED DESCRIPTION OF THE INVENTION

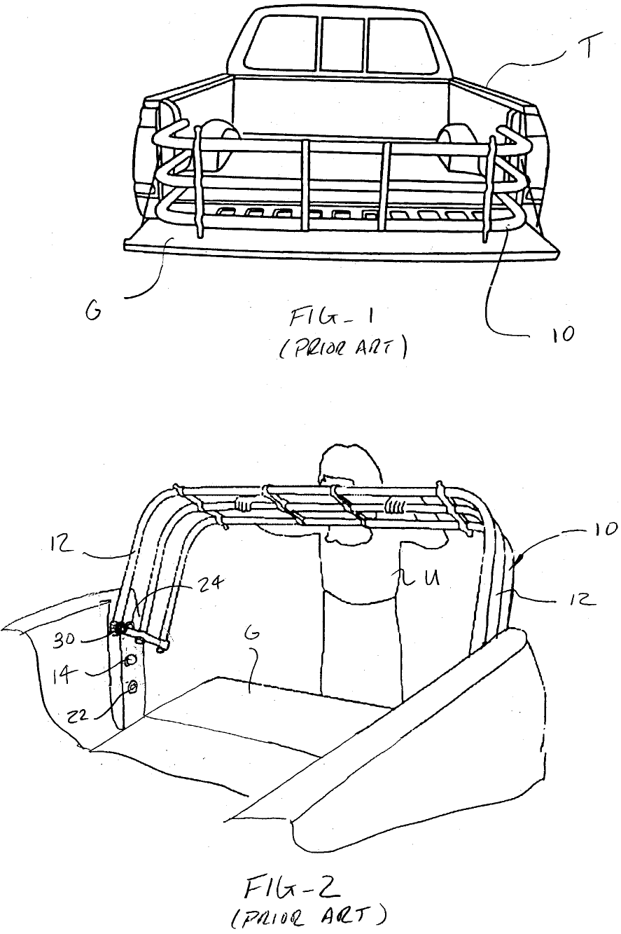

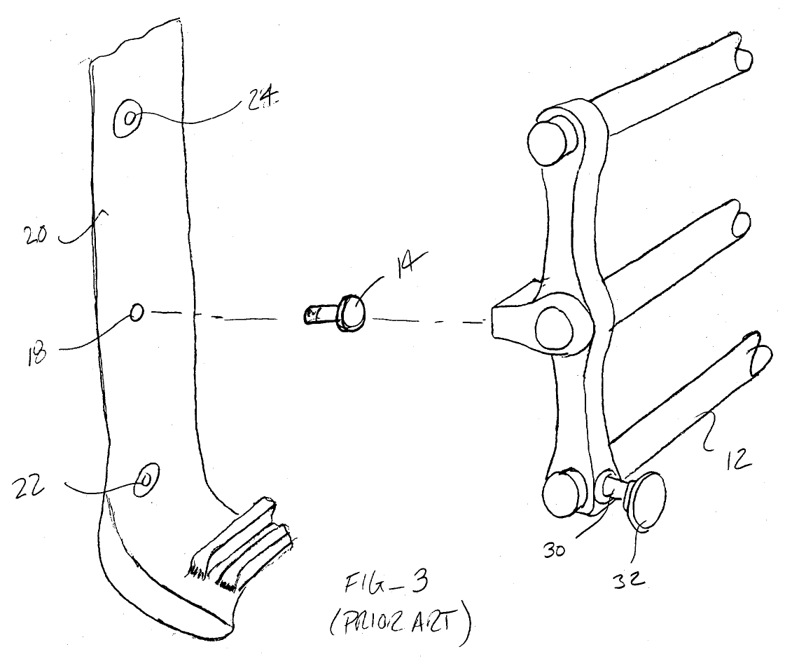

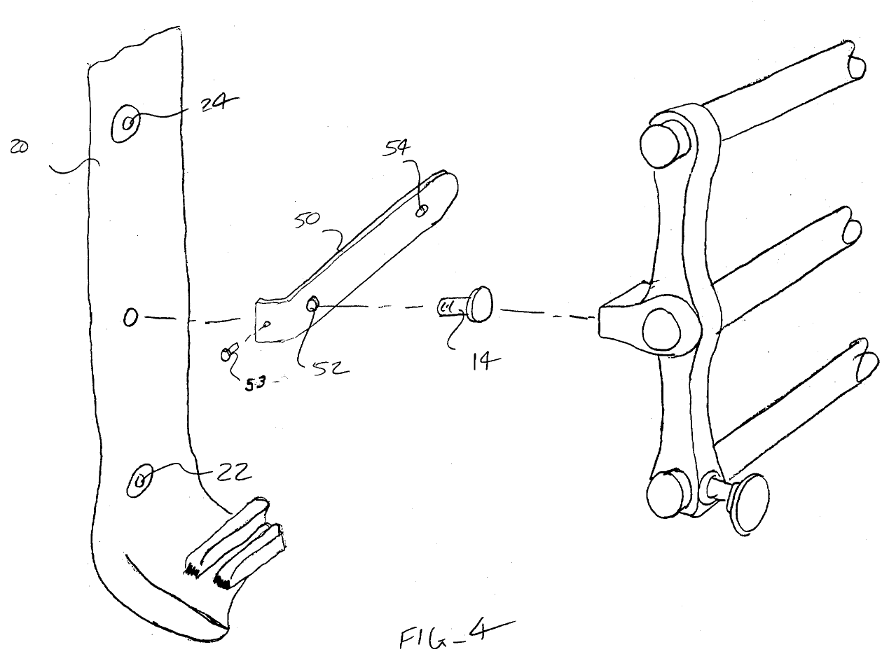

Referring to FIGS. 1-3, a particular truck bed extension system which may be modified using the methods, systems, and apparatus of the present invention will be described. The system is presently commercially available under the trade name Bed X-tender truck bed system from AMP Research, Inc., of Irvine, Calif. The system comprises a U-shaped frame 10 which may be mounted at the rear end of a pick-up truck T, as shown in FIGS. 1 and 2. The frame 10 may be positioned and removed by a user U by securing the side walls 12 to pivot pins 14 (as best seen in FIGS. 2 and 3). The pivot pin 14 is removably secured in a hole 18 on a vertical surface 20 of the truck bed. Anchor holes 22 and 24 are vertically aligned with the pivot pin 14 and spaced above and below the pin by equal distances. The side wall 12 of the U-shaped frame 10 includes a locking pin assembly 30 having a shaft and a handle 32. When the frame is mounted in the tailgate of the truck T as shown in FIG. 1, the pin 30 may be locked into anchor hole 22 on the frame when positioned forwardly, i.e. toward the cab. Conversely, the pin 30 will be received in the upper anchor hole 24 when the frame is rotated so that it lies rearwardly, i.e. over the tailgate G as shown in FIG. 1.

As described thus far, the truck bed extender system of FIGS. 1-3 is entirely conventional. It will be appreciated that the frame has two lockable positions. The first lockable position is shown generally in FIG. 1 where the pin 30 is secured in upper hole 24. The second position (not illustrated) where the frame is positioned forwardly toward the cab allows pin 30 to be received in the lower anchor hole 22. At all other positions, however, the pin 30 is unsecured and the frame is not locked relative to the truck bed.

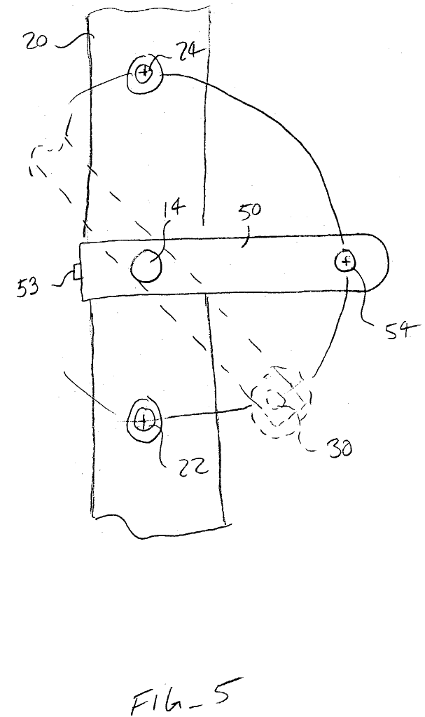

According to the present invention, a bracket 50 (FIGS. 4 and 5) may be mounted on the vertical surface 20. Conveniently, the bracket 50 may be mounted by removing the pre-existing pivot pin 14 and using the pivot pin to secure the bracket through a hole 52. Alternatively, of course, customized pivot pins 14 could be prepared for use with the present invention. Bracket 50 is mounted both by securing with the pivot pin 14 and tightening using a tensioning screw 53. The bracket includes an anchor hole 54 which has the same size as the anchor holes 22 and 24. In this way, as illustrated in FIG. 5, a pattern of three anchor holes 22, 24, and 54 is now formed about the pivot pin 14. The anchor holes are all equidistant from the pivot pin so that they each may removably receive the locking pin 30 when the U-shaped frame is in the appropriate position. In particular, the locking pin 30 will be received in the bracket hole 54 when the frame is positioned vertically, i.e. straight up relative to the plane of the truck bed. The frame may be released from the vertical position (or any of the other two positions) by releasing the locking pin and manually moving the frame to another position.

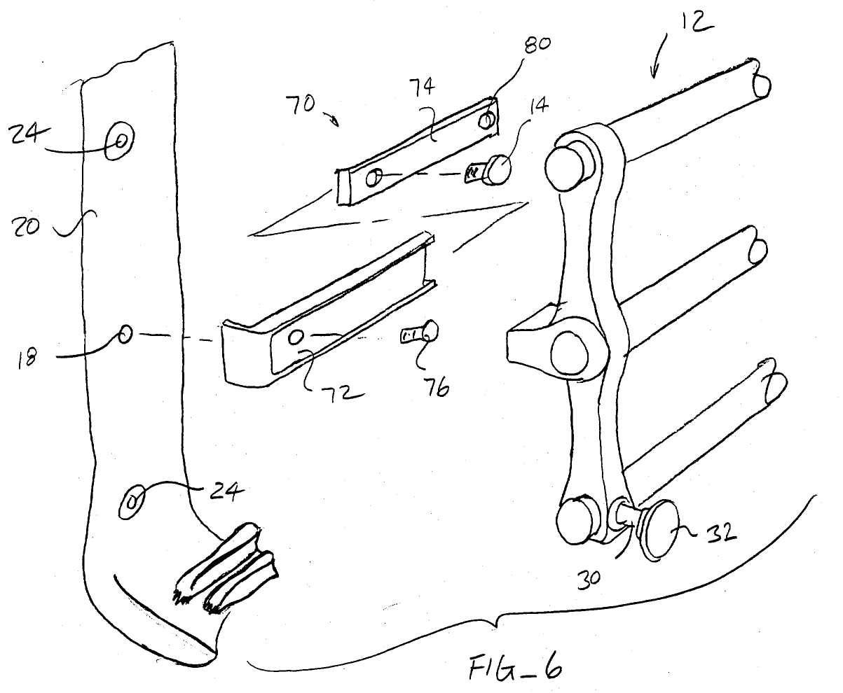

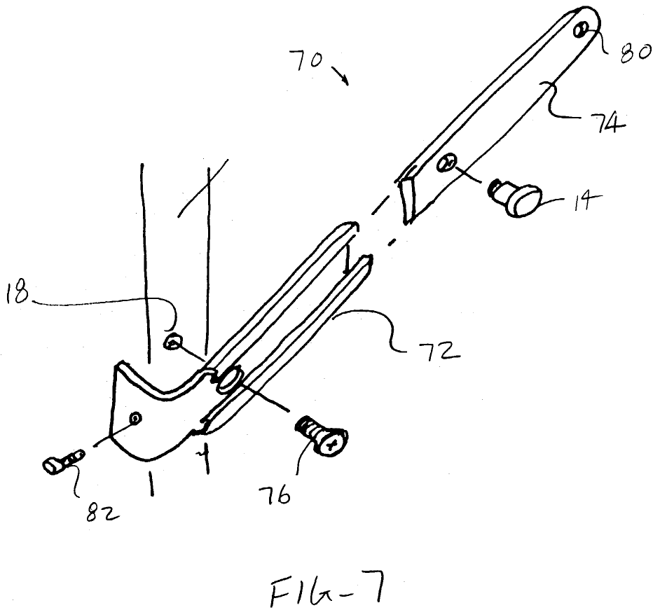

Use of the bracket 50 allows the locking positioning of the U-shaped frame 10 into three positions, i.e. forward horizontal, rearward horizontal, and vertical. When the frame is in the vertical position, however, a portion of the frame will remain within the tailgate opening, thus preventing closure of the tailgate. In many instances, it may be desirable to be able to raise the frame into the vertical position while allowing for closing the tailgate. To achieve that end, a second bracket embodiment 70 constructed in accordance with the principles of the present invention is provided, as illustrated in FIGS. 6-9. Bracket 70 comprises a base 72 and a slide 74. The base 72 is secured on the vertical surface 20 of the truck bed using a screw or other fastener 76 which secures the base into the hole 18. A slide 74 receives the pivot pin 14 and includes an anchor hole 80. The distance between the pivot pin 14 and the anchor hole 80 will be identical to that between the hole 18 and anchor holes 22 and 24. Assembly of the bracket 70 is illustrated in FIG. 7. A tensioning screw 82 may be provided in order to firmly secure the base 72 to the vertical surface 20.

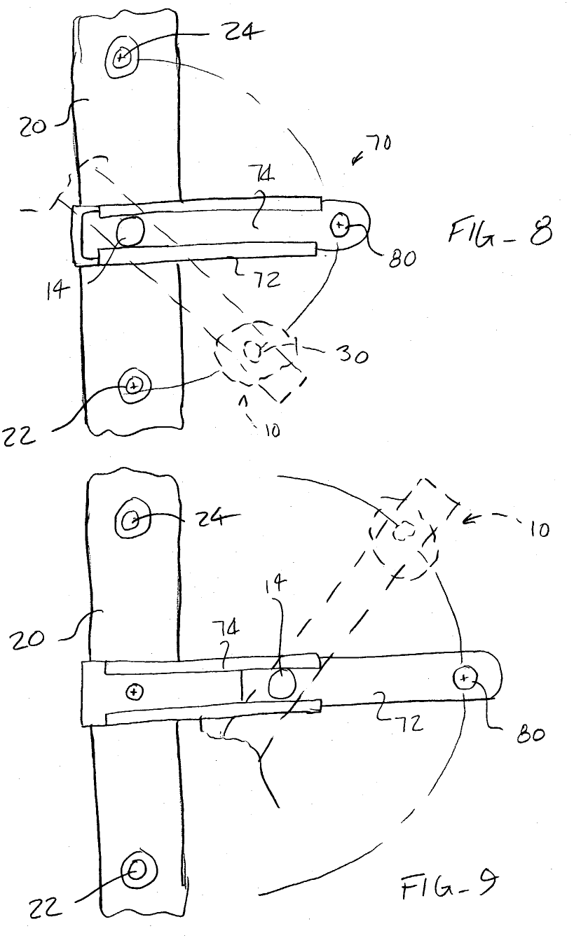

As shown in FIG. 8, the bracket 70 may provide a pattern of three anchor holes 22, 24, and 80, which is similar to the pattern provided by the first embodiment of the bracket 50. The slide 74 is positioned rearwardly in the base 72 so that the pivot pin 14 is aligned directly over hole 18 (FIG. 6), and the U-shaped frame may be secured at any of the two horizontal or one vertical positions by selective use of locking pin 30.

By moving the slide 72 forwardly relative to the bracket 74 (and also relative to the truck bed), pivot pin 14 will be moved out of vertical alignment with the vertical surface 20, as illustrated in FIG. 9. While the U-shaped frame 10 will no longer be able to be locked in either of the horizontal positions, it will continue to be able to be locked in the vertical position since the anchor hole 80 remains the requisite distance from the pivot pin since they are both fixed on the slide 72. Thus, the U-shaped frame 10 will be able to be moved inwardly toward the cab of the truck bed while retaining the ability to be locked in the vertical position. In this way, the frame can be both raised and locked, while being moved out of the way of the tailgate. The tailgate may thus be closed while the frame remains raised.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A method for modifying a truck bed extender structure, wherein said truck bed extender comprises a U-shaped frame having a pair of side walls joined by a back wall, wherein the side walls are adapted to pivotally attach to a vertical surface in a truck bed so that the U-shaped frame may be pivoted between a first rearwardly extended horizontal position and a second forwardly shortened horizontal position, wherein the method comprises:
establishing at least a third position wherein the U-shaped frame is generally vertical and locked so that it remains in said third position until released.

2. A method as in claim 1, wherein establishing the at least third position comprises mounting a bracket on the vertical surface of the truck bed, wherein the bracket provides an anchor point which receives a releasable latch on the U-shaped frame.

3. A method as in claim 2, wherein the anchor point is an opening and the releasable latch is a locking pin which reciprocatably mates with the opening when the U-shaped frame is in its vertical third position.

4. A method as in claim 3, wherein mounting the bracket comprises securing the bracket to the vertical surface with a pivot pin which receives and supports the side wall of the U-shaped frame.

5. A method as in claim 3, wherein the bracket comprises a base and a slide, wherein the base is mounted on the vertical surface and the slide includes the opening and a pivot pin which pivotally attaches the side wall of the U-shaped frame, whereby the U-shaped frame may be moved horizontally relative to the truck bed by sliding the slide in the base.

6. An improved truck bed extender system of the type including a U-shaped frame having a pair of side walls joined by a back wall, wherein the side walls are adapted to pivotally attach to opposed vertical surfaces across the rear of a truck bed so that the U-shaped frame may be pivoted between a rearwardly extended horizontal position and a forwardly shortened horizontal position, wherein the improvement comprises:
a first bracket mountable on a first vertical surface of the truck bed, wherein the first bracket provides an anchor point which receives a releasable latch on the U-shaped frame to lock said U-shaped frame in a third generally vertical position.

7. An improved truck bed extender system as in claim 6, wherein the improvement further comprises a second bracket mountable on a second vertical surface of the truck bed, wherein the second bracket which receives a releasable latch on the U-shaped frame to lock said U-shaped frame in the third generally vertical position.

8. An improved truck bed extender system as in claim 6, wherein the bracket has an opening which defines the anchor point and which receives a reciprocatable locking pin on the side wall of the U-shaped frame.

9. An improved truck bed extender system as in claim 8, wherein the bracket comprises a base and a slide, wherein the base is mountable on the vertical surface of the truck bed and the slide includes the opening and the anchor point, whereby the U-shaped frame may be moved horizontally relative to the truck bed by sliding the slide in the base.

10. For use in combination with a truck bed extender structure comprising a U-shaped frame having a pair of side walls joined by a back wall, wherein the side walls are adapted to pivotally attach to a vertical surface in a truck bed so that the U-shaped frame may be pivoted between a rearwardly extended horizontal position and a forwardly shortened horizontal position, a bracket comprising:
a base mountable on the vertical surface of the truck bed, wherein the bracket comprises an anchor point which receives a releasable latch on the U-shaped frame to lock said U-shaped frame in a third generally vertical position.

11. A bracket as in claim 10, wherein the base comprises an opening which defines the anchor point and which receives a reciprocatable locking pin on the side wall of the U-shaped frame.

12. A bracket as in claim 11, further comprising a slide which is slidably received in the base, wherein the slide comprises an opening which defines the anchor point and which receives a reciprocatable locking pin on the side wall of the U-shaped frame, whereby the U-shaped frame may be moved horizontally relative to the truck bed by sliding the slide in the base.
